(19) United States
(12) Patent Application Publication
(10) Pub. No.: US 2024/0296396 A1
(43) Pub. Date: Sep. 5, 2024

(54) PROGRAM ORGANIZATION SYSTEM, PROGRAM ORGANIZATION METHOD, AND RECORDING MEDIUM

(71) Applicant: NEC Corporation, Tokyo (JP)

(72) Inventors: Fumihide TAKIMOTO, Tokyo (JP); Munehiro Hashimoto, Tokyo (JP); Yuka Endo, Tokyo (JP)

(73) Assignee: NEC Corporation, Tokyo (JP)

(21) Appl. No.: 18/581,916

(22) Filed: Feb. 20, 2024

(30) Foreign Application Priority Data
Mar. 2, 2023 (JP) 2023-031953

(51) Int. Cl. G06Q 10/0631

(52) U.S. Cl. CPC G06Q 10/0631

(57) ABSTRACT

A program organization system includes an acquisition unit, an organization unit, and an output unit. The acquisition unit acquires information regarding a race of public competition. The organization unit organizes a program for the race based on a setting of a difficulty level of race result prediction, from the acquired information regarding the race of the public competition, by using an organization model that organizes the program according to the setting of the difficulty level of race result prediction, from the information regarding the race of the public competition. The output unit outputs the organized program. The program organization system can, for example, support decision making in race organization.

This application is based upon and claims the benefit of priority from Japanese Patent Application No. 2023-31953, filed on Mar. 2, 2023, the disclosure of which is incorporated herein in its entirety by reference.

### TECHNICAL FIELD

The present disclosure relates to a program organization system and the like.

### BACKGROUND ART

In public competition, for example, for each race, an organizer determines competitors or racehorses that will run in the race. For example, a program generation program of PTL 1 (JP 2020-060875 A) allocates players participating in a race to each race using a plurality of rules.

### SUMMARY

An object of the present disclosure is to provide a program organization system and the like capable of easily organizing a program according to a setting of a difficulty level of race result prediction.

A program organization system according to an aspect of the present disclosure includes at least one memory storing instructions, and at least one processor configured to execute the instructions to acquire information regarding a race of public competition, organize a program for the race based on a setting of a difficulty level of race result prediction, from the acquired information regarding the race of the public competition, by using an organization model that organizes the program according to the setting of the difficulty level of race result prediction, from the information regarding the race of the public competition, and output the organized program.

A program organization method according to an aspect of the present disclosure includes acquiring information regarding a race of public competition, organizing a program for the race based on a setting of a difficulty level of race result prediction, from the acquired information regarding the race of the public competition, by using an organization model that organizes the program according to the setting of the difficulty level of race result prediction, from the information regarding the race of the public competition, and outputting the organized program.

A non-transitory recording medium according to an aspect of the present disclosure non-temporarily records a program organization program that causes a computer to execute acquiring information regarding a race of public competition, organizing a program for the race based on a setting of a difficulty level of race result prediction, from the acquired information regarding the race of the public competition, by using an organization model that organizes the program according to the setting of the difficulty level of race result prediction, from the information regarding the race of the public competition, and outputting the organized program.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of an information processing system according to an example embodiment of the present disclosure;

FIG. 2 is a diagram illustrating an example of a configuration of a program organization system according to an example embodiment of the present disclosure;

FIG. 3 is a diagram schematically illustrating an example of a graph of a desire for purchase according to an example embodiment of the present disclosure;

FIG. 4 is a diagram illustrating an example of a display screen according to an example embodiment of the present disclosure;

FIG. 5 is a diagram illustrating an example of a display screen according to an example embodiment of the present disclosure;

FIG. 6 is a diagram illustrating an example of a display screen according to an example embodiment of the present disclosure;

FIG. 7 is a diagram illustrating an example of a display screen according to an example embodiment of the present disclosure;

FIG. 8 is a diagram illustrating an example of a display screen according to an example embodiment of the present disclosure;

FIG. 9 is a diagram illustrating an example of a display screen according to an example embodiment of the present disclosure;

FIG. 10 is a diagram illustrating an example of an operation flow of the program organization system according to an example embodiment of the present disclosure;

FIG. 11 is a diagram illustrating an example of an operation flow of the program organization system according to an example embodiment of the present disclosure; and

FIG. 12 is a diagram illustrating an example of a hardware configuration according to the present disclosure.

### EXAMPLE EMBODIMENT

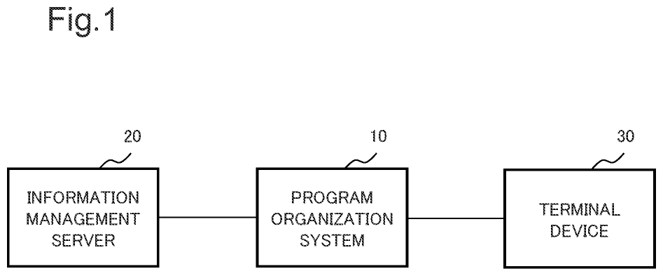

Example embodiments of the present disclosure will be described in detail with reference to the drawings. FIG. 1 is a diagram illustrating an example of a configuration of an information processing system according to the present example embodiment. As an example, the information processing system according to the present example embodiment includes a program organization system 10, an information management server 20, and a terminal device 30. The program organization system 10 is connected to the information management server 20 via a network. The program organization system 10 is connected to the terminal device 30 via a network. A plurality of information management servers 20 and a plurality of terminal devices 30 may be provided.

The program organization system 10 is a system that organizes a program of a race in public competition. The public competition is, for example, a horse race. The public competition may be a bicycle race, a boat race, or an auto race. The example of the public competition is not limited to what is mentioned above, and the type of sports competition is not limited as long as it is competition held by a public institution for gambling purposes.

The program of the race is, for example, a combination of competitors who will run in the race. The competitor is an entity that participates in the race. In a case where the public competition is a horse race, the competitor is a horse. In a case where the public competition is a bicycle race, a boat race, or an auto race, the competitor is a player. The program may include a condition of each of the competitors who will run in the race. The condition of each of the competitors running in the race is, for example, information on a lane assigned to the competitor who will run in the race. The condition of each of the competitors who will run in the race may be a handicap imposed on each of the competitors.

The program organization system 10 organizes the program of the race for the public competition by using an organization model. The organization model is a learning model that organizes a program of a race from information regarding the race for the public competition and a difficulty level of race result prediction. The organization model may be a learning model generated outside the program organization system 10. The organization model will be described later.

The information regarding the race is, for example, information required to organize a program of the race and information that can affect a difficulty level of race result prediction. The information regarding the race is, for example, a race condition, a candidate competitor who will run in the race, and an attribute of the candidate competitor who will run in the race. For example, assumed odds on voting tickets for a race are used as indices of the difficulty level of race result prediction. The assumed odds are odds expected for each race by an organizer of the race. For example, the higher the odds, the higher the difficulty level of race result prediction. Therefore, when the organizer of the race wants to set the difficulty level of the race high, the organizer of the race sets the assumed odds high.

The race condition is, for example, information regarding a stadium, a race setting condition, or a condition to be satisfied by a competitor running in the race. The attribute of the competitor is information on each competitor participating in the race. In a case where the public competition is a horse race, the attribute of the competitor may also include information regarding a rider. In a case where the public competition is a bicycle race, a boat race, or an auto race, the attribute of the competitor may also include information on a bicycle, a boat, or a motorcycle. The information regarding the race is not limited to the above-described examples.

The race condition and the attribute of the competitor who will run in the race can affect the difficulty level of race result prediction. For example, in a case where the race is long, a program including many competitors having winning records in long races has a high difficulty level of race result prediction. When the difficulty level of race result prediction is high, differences in race result prediction between people who purchases voting tickets for the race are great, resulting in high odds on the voting tickets in the actual race.

The difficulty level of race result prediction can affect whether to purchase a voting ticket for the race. The difficulty level of race result prediction can affect the voting ticket sales amount for the race. When the difficulty level of race result prediction is high, for example, there is a low possibility that the race result prediction matches an actual race result, and a payout amount is high. Therefore, the race may be an improved attraction as a target for which a voting ticket is to be purchased. On the other hand, when the difficulty level of race result prediction is high, it is difficult for a beginner to predict the race, and the race may be excluded by the beginner from targets for which voting tickets are to be purchased. Therefore, the organizer of the race sets the difficulty level of race result prediction, for example, according to a group of purchasers assumed as people who purchase voting tickets for the race.

The information management server 20 is, for example, a server that stores information regarding the race of the public competition. The information regarding the race is, for example, a race condition, and a candidate of a competitor who will run in the race, and an attribute of each competitor. The information management server 20 may store data concerning a past race in which information regarding the race, a difficulty level of race result prediction, and a program of the race are associated with each other.

The terminal device 30 is, for example, a terminal device used by a person who uses a result of program organization by the program organization system 10 to browse the organization result. The result of program organization is, for example, a program organized by the organization model from the information regarding the race. The program organized by the organization model is, for example, information in which the race condition and the competitor who will run in the race are associated with each other. The person who uses the result of program organization is, for example, a person who is in charge of the program organization in the organizer of the race. The person who uses the result of program organization may be a person who considers a racehorse owned by the person as a candidate for the race in which the racehorse will run. The person who uses the result of program organization is not limited to the above-described examples.

For example, the program organization system 10 acquires the information regarding the race from the information management server 20. Then, with the information regarding the race acquired from the information management server 20 and the difficulty level of race result prediction as inputs, the program organization system 10 organizes a program of the race using the organization model. After organizing the program of the race, the program organization system 10 outputs a result of program organization to the terminal device 30.

The program organization system 10 may acquire the information regarding the race from a plurality of information management servers 20. The program organization system 10 may acquire the information regarding the race from the terminal device 30.

The program organization system 10 may output a result of program organization for the race to a plurality of terminal devices 30. For example, the program organization system 10 may output the result of program organization for the race to terminal devices 30 used by a plurality of users, respectively. The program organization system 10 may output the result of program organization for the race to the information management server 20.

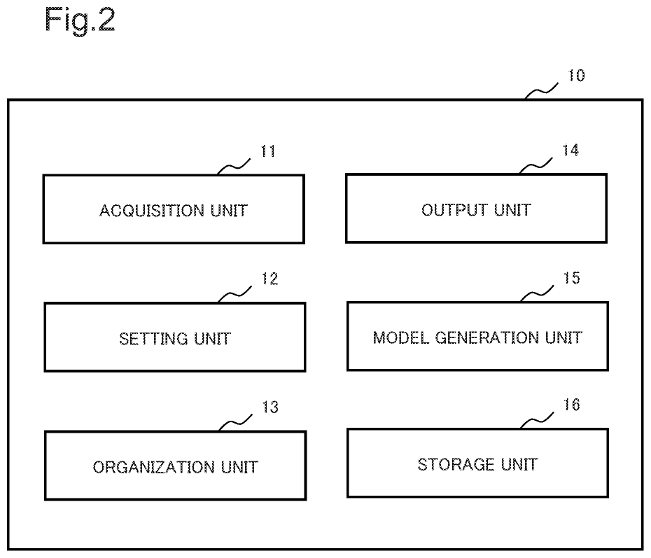

Next, a configuration of the program organization system 10 will be described. FIG. 2 is a diagram illustrating an example of a configuration of the program organization system 10. The program organization system 10 includes an acquisition unit 11, an organization unit 13, and an output unit 14 as a basic configuration. The program organization system 10 includes a setting unit 12, a model generation unit 15, and a storage unit 16.

The acquisition unit 11, the setting unit 12, the organization unit 13, the output unit 14, and the storage unit 16 of the program organization system 10 perform, for example, processes related to organization of a program for a race. The model generation unit 15 and the storage unit 16 perform, for example, processes related to generation of an organizational model.

The acquisition unit 11 acquires information regarding a race of public competition. The information regarding the race is, for example, information that can relate to the organization of the program of the race. The acquisition unit 11 acquires, for example, a race condition, and a candidate of a competitor who will run in the race, and an attribute of each competitor as the information regarding the race.

In a case where the public competition is a horse race, the race condition is, for example, information regarding a racetrack, a race setting condition, or a condition to be satisfied by a racehorse running in the race. The race condition may include a date when the race is held.

The race condition is, for example, at least one of a distance, a type of a horse track, a condition for a racehorse, a basis weight, a rating of a race, a race course, the number of racehorses running in the race, and a running direction. The type of the horse track is, for example, turf, dirt or obstacle. The condition for the racehorse is, for example, a condition for running in the race defined by horse age and sex. The running direction is, for example, information indicating whether the race is performed counterclockwise or clockwise. In a case where the public competition is a horse race, the race condition is not limited to the above-described examples. In a case where the public competition is a horse race, the candidate of the competitor who will run in the race is a candidate of a racehorse that will run in the race.

In a case where the public competition is a horse race, the attribute of the competitor is an attribute of a racehorse. The attribute of the racehorse is information on each racehorse. The attribute of the racehorse is, for example, at least one of age, sex, weight, change in weight, blood data, muscle mass, training status, health condition, rest history, race participation history, weight bearing, leg quality, race record, bloodline, horse owner, stable, trainer, and producer. The bloodline is, for example, information on a father horse and a mother horse. The attribute of the racehorse may include a rider. The training situation is, for example, a time and a time change for each distance during training. The leg quality is set by, for example, a classification into a runaway horse, a preceding horse, a leading horse, or a chasing horse. The attribute of the racehorse may include race records of the father horse and the mother horse. The race record is, for example, concerning a past race, a race condition, an attribute of a racehorse at the time of the race, an acquired prize money, or a race development. The lace development is, for example, positioning or a difference in arrival. The positioning is, for example, a rank and a time in each section when the entire race is divided for each predetermined distance. The difference in arrival is, for example, a time difference from a high-rank racehorse or a low-rank racehorse. The attribute of the racehorse is not limited to the above-described examples.

In a case where the public competition is a bicycle race, the race condition is, for example, at least one of a race course and a competition distance. The attribute of the competitor is at least one of a height, a weight, an age, a leg quality, and a race record of a player. In a case where the public competition is a bicycle race, the race condition and the attribute of the competitor are not limited to the above-described examples.

In a case where the public competition is a boat race, the race condition is, for example, at least one of a race course and a competition distance. The attribute of the competitor is at least one of a height, a weight, an age, a rank, and a race record of a player. In a case where the public competition is a boat race, the race condition and the attribute of the competitor are not limited to the above-described examples.

In a case where the public competition is an auto race, the race condition is, for example, at least one of a race course and whether there is a handicap. The attribute of the competitor is at least one of a height, a weight, an age, a management agency, a class, and a race record of a player. In a case where the public competition is an auto race, the race condition and the attribute of the competitor are not limited to the above-described examples.

The acquisition unit 11 may acquire a setting for the difficulty level of race result prediction. The acquisition unit 11 acquires the setting for the difficulty level of race result prediction, for example, from the terminal device 30. The setting for the difficulty level of race result prediction is input to the terminal device 30, for example, by a person in charge of organizing a program.

In a case where a plurality of organization models is used, the acquisition unit 11 may acquire a designation of an organization model to be used by the organization unit 13 from the terminal device 30. The designation of the organization model is acquired, for example, from the terminal device 30 to which the designation of the organization model is input by an operation of a person who uses an organization result.

When the program organization system 10 generates an organization model, the acquisition unit 11 may acquire information regarding the race, a difficulty level of the race, and a program of the race as teacher data for generating the organization model. For example, the acquisition unit 11 acquires data in which the race condition, the attribute of the competitor who has run in the race, the difficulty level of the race, and the program of the race are associated with each other.

For example, the setting unit 12 sets the difficulty level of race result prediction. The difficulty level of race result prediction is set, for example, based on assumed odds in the race. The assumed odds in the race used as the difficulty level is, for example, an assumed value of a ratio of a payout amount when a first place and a second place in the race are correctly predicted. The ratio of the payout amount is a ratio of the payout amount to a purchase amount when one voting ticket is purchased.

As the odds in the race used as the difficulty level, an assumed value of the most popular odds among assumed odds on voting tickets in the race is used. The assumed value of the most popular odds is, for example, an assumed value of the odds in a combination having the lowest odds among combinations of competitors that can be purchased as voting tickets. For example, in a case where the public competition is a horse race, an assumed value of the most popular odds for horse-number exacta is used as the assumed odds in the race used as the difficulty level. As the assumed odds in the race used as the difficulty level, an average value of assumed odds on a preset number of combinations of competitors from one having the highest odds among combinations of competitors that can be purchased as voting tickets may be used. In a case where the assumed values of odds on the preset number of combinations of competitors from one having the highest odds are used as the difficulty level, the difficulty level may be calculated while the weight of the higher combination is largest.

The difficulty level of race result prediction may be set using assumed values of odds for a plurality of purchase methods among the methods of purchasing voting tickets. For example, in a case where the public competition is a horse race, the difficulty level of race result prediction may be set using horse-number perfecta and frame-number quinella. The setting of the difficulty level of race result prediction using the assumed value of the odds is not limited to the above-described examples.

The difficulty level of race result prediction may be expressed using a rank of the difficulty level. For example, the difficulty level of race result prediction is set to be higher as the numeral representing one of a plurality of ranks is larger. The setting of the difficulty level of race result prediction using the rank of the difficulty level is not limited to what has been described above.

For example, the setting unit 12 sets the difficulty level based on at least one of a desire of a voting ticket purchaser for purchase for the race and a skill level of the voting ticket purchaser for the race. The skill level of the voting ticket purchaser for the race is, for example, a skill level of a purchaser group targeted as the voting ticket purchaser. The targeted voting ticket purchaser is, for example, a purchaser group that the organizer of the race wants to purchase voting tickets.

For example, the setting unit 12 sets the difficulty level of race result prediction high in a period in which a voting ticket purchaser has a high desire for purchase for the race. The high desire of the purchaser for purchase means that the desire to purchase the voting ticket is high, for example, when the voting ticket purchaser is well-financed after the salary payment date and the bonus payment date of the purchaser. The relationship between the desire of the voting ticket purchaser for purchase and the difficulty level of race result prediction is set, for example, in advance.

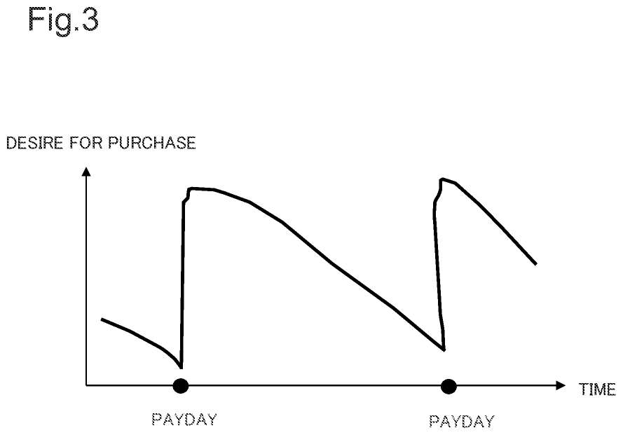

FIG. 3 is a diagram schematically illustrating an example of a graph of a desire of a voting ticket purchaser for purchase. The example of the graph of FIG. 3 is a graph in which the horizontal axis is set as a time and the vertical axis is set as a desire for purchase. The desire for purchase is, for example, a value obtained by scoring the desire for purchase. In the example of the graph of FIG. 3, the desire of the voting ticket purchaser for purchase decreases after increasing on the salary payment day of the purchaser indicated as a payday. Therefore, in the example of the graph of FIG. 3, since the amount of money held by the purchaser increases on and after the payday, the desire to purchase the voting ticket can be improved. In addition, when the desire for purchase is high, the voting ticket purchaser is highly likely to purchase a voting ticket of which a payout amount is high relative to the purchase amount. On the other hand, when the desire for purchase is low, the voting ticket purchaser is highly likely to purchase a voting ticket of which a payout is easy to obtain even though the payout amount is low relative to the purchase amount. Therefore, by setting the difficulty level according to the desire of the voting ticket purchaser for purchase, the voting ticket sales amount can be improved.

The setting unit 12 sets the difficulty level in such a way that the higher the skill level of the voting ticket purchaser for the race, the higher the difficulty level of race result prediction. The high skill level of the voting ticket purchaser for the race means that, for example, many voting ticket purchasers for races frequently purchase voting tickets and are familiar with prediction of results. For example, the skill level of the voting ticket purchaser for the race is classified into one of three stages including an advanced level, an intermediate level, and a beginner level. The targeted skill level of the purchaser is set by, for example, the organizer of the race. The relationship between the skill level of the voting ticket purchaser and the difficulty level of race result prediction is set, for example, in advance. The difficulty level of race result prediction may be set based on a ratio in the number of voting ticket purchasers between skill levels.

The setting unit 12 sets the difficulty level of race result prediction high when the skill level of the voting ticket purchaser for the race is high. For example, an advanced-level person is highly likely to purchase a voting ticket of which a payout amount is high relative to the purchase amount. On the other hand, a beginner-level person is highly likely to purchase a voting ticket of which a payout is easy to obtain even though the payout amount is low relative to the purchase amount.

The setting unit 12 may estimate the difficulty level by using an estimation model that estimates a difficulty level of race result prediction from the information regarding the race. For example, using an estimation model that estimates a difficulty level at which a voting ticket sales amount increases from the information regarding the race, the setting unit 12 estimates a difficulty level to be set to a race for which a program is to be organized.

Using the organization model, the organization unit 13 organizes a program according to the setting of the difficulty level of race result prediction from the information regarding the race acquired by the acquisition unit 11. The organization model is a learning model that organizes a program for a race according to a setting of a difficulty level of race result prediction from information regarding the race. The organization unit 13 organizes, for example, a program according to the setting of the difficulty level set by the setting unit 12. The organization unit 13 may organize a program according to the setting of the difficulty level acquired by the acquisition unit 11.

The organization model organizes a program for the race based on the setting of the difficulty level of race result prediction, from the information regarding the race of the public competition. With the information regarding the race as an input, the organization model organizes a program for the race according to the setting of the difficulty level of race result prediction. Then, the organization model outputs the organized program for the race. The program for the race according to the setting of the difficulty level of race result prediction is, for example, a program that satisfies the setting of the difficulty level of race result prediction. For example, in a case where the difficulty level of race result prediction is set using assumed odds on voting tickets, the organization model organizes a program satisfying the assumed odds. The program satisfying the assumed odds is, for example, a program in which, when a race is performed based on the program organized by the organization model, the odds based on the actual race result can be the assumed odds. The difficulty level of race result prediction may be set to have a set value width.

The information regarding the race is, for example, a race condition, a candidate competitor who will run in the race, and an attribute of the candidate competitor who will run in the race. The organization model outputs, for example, a combination of competitors who will run in the race among the candidate competitors who will run in the race as the program for the race. The organization model outputs, for example, names of competitors assigned to the race for which the program is organized. The organization model may output the race condition and a combination of competitors who will run in the race. The organization model determines a combination of competitors to be assigned to the race to be organized from among the candidate competitors who will run in the race in such a way as to satisfy the set difficulty level. The organization model may calculate a degree of appropriateness with respect to the race for each candidate competitor who will run in the race as an index. For example, the degree of appropriateness with respect to the race is set as an index for which a candidate competitor is allocated to the race with a higher priority as its degree of appropriateness is higher. Then, the organization model determines a sports competition to be assigned to the race for which the program is to be organized based on the degree of appropriateness to satisfy the setting of the difficulty level of race result prediction.

The organization unit 13 may organize the program for the race using the organization model according to a skill level of a person assumed as a person who purchase a voting ticket for the race. The skill level is, for example, a beginner level, an intermediate level, or an advanced level. The skill level may be set based on the number of times voting tickets are purchased or a record of obtaining payouts of voting tickets. The skill level is set by, for example, a rank according to the number voting tickets are purchased or a record of obtaining payouts of voting tickets.

The organization unit 13 may organize the program for the race using an organization model according to a rating of the race. The organization unit 13 uses different organization models, for example, in a normal race and in a race having a higher rating than the normal race. In the race with a high rating, there are various voting ticket purchasers. For example, in a normal race, the ratio of the number of highly skilled persons to the number of voting ticket purchasers for the race is high. On the other hand, in a race with a high rating, the ratio of the number of beginners to the number of voting ticket purchasers for the race may be higher than that in a normal race. Therefore, a tendency of a voting ticket purchaser for the race toward race result prediction may vary depending on a rating of the race. Therefore, by using a different organization model according to the rating of the race, the program organizing accuracy can be improved. The organization unit 13 may organize the program for the race using an organization model according to a voting ticket sales amount for the race. In a case where a plurality of organization models are used, the classification of the organization models is not limited to what has been described above.

The organization unit 13 may organize a program for each of a plurality of races based on the difficulty level of race result prediction set for each race. In a case where a program is organized for each of the plurality of races, the organization model organizes a program for each of the plurality of races, for example, by allocating candidate competitors who will run in the race to each of the plurality of races. For example, in a case where the public competition is a horse race, and the number of candidate racehorses that will run in the race is 50, the organization model assigns each of the 50 racehorses to any race. The number of candidates who will run in the race may be larger than the number of competitors who will run in the race. That is, there may be a candidate who is not allocated to the race.

The organization unit 13 may predict a voting ticket sales amount for the race performed based on the organized program. For example, when organizing a program for the race, the organization unit 13 predicts a voting ticket sales amount for the race using an organization model that further predicts a voting ticket sales amount for the race to be performed based on the organized program. The voting ticket sales amount for the race may vary depending on the difficulty level of race result prediction and the program for the race. The organization model is for organizing a program for the race, for example, to satisfy the setting of the difficulty level of race result prediction, and for predicting a voting ticket sales amount for the race performed based on the organized program. The organization model is generated, for example, by learning, concerning a race performed in the past, a relationship of a program and a relationship of sales with information regarding the race and a difficulty level of the race. Using a learning model different from the organization model, the organization unit 13 may predict a voting ticket sales amount for the race performed based on the program organized by the organization model.

In a case of an organization model capable of extracting a reason for organizing a program, the organization unit 13 may extract a reason for organizing the program, using the organization model, at the time of organizing the program for the race.

The output unit 14 outputs a result of organizing the program for the race. The output unit 14 outputs the result of organizing the program for the race, for example, to the terminal device 30. The output unit 14 may output the result of organizing the program for the race to a display device connected to the program organization system 10, which is not illustrated. In a case where the organization unit 13 extracts a reason for organizing the program, the output unit 14 may output the reason for organization together with the result of organizing the program for the race.

In a case where the organization unit 13 predicts a voting ticket sales amount, the output unit 14 may additionally output a result of predicting the voting ticket sales amount. The output unit 14 outputs the result of predicting the voting ticket sales amount in addition to the result of organizing the program for the race, for example, to the terminal device 30.

The output unit 14 may output a display screen for performing an operation of changing a competitor included in the program organized by the organization unit 13. In a case where a competitor included in the program organized by the organization unit 13 is changed, the output unit 14 outputs, for example, a candidate for a replacing competitor. The output unit 14 outputs, for example, a competitor having a similar attribute to the competitor included in the program as the candidate for the replacing competitor. The output unit 14 outputs, for example, a competitor that is not assigned to the race among competitors grouped in advance, each group of competitors having similar attributes, as the candidate for the replacing competitor. For example, each group for competitors having similar attributes is set in advance as a group of competitors that are similar in age, sex, and race record. In a case where the organization model organizes a program using an index, the output unit 14 may output, as the candidate for the replacing competitor, a competitor having a high score among competitors who are not included in the program when the program is organized by the organization model.

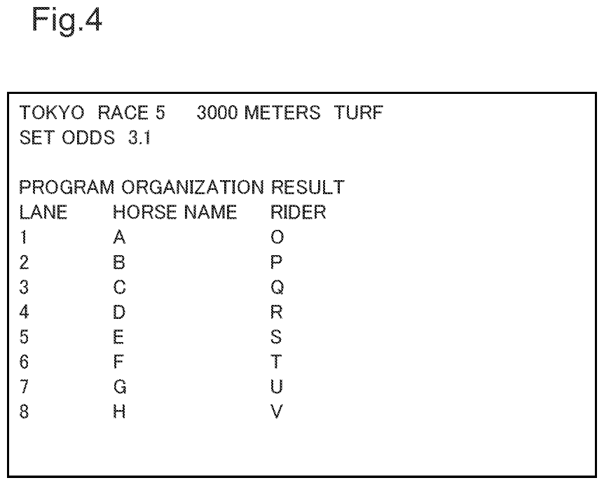

FIG. 4 is an example of a screen where a result of organizing a program for a race is displayed in a case where the public competition is a horse race. In the example of the display screen of FIG. 4, “Tokyo” indicating a name of a racetrack, “Race 5” indicating a race number, “3000 meters” indicating a race distance, and “turf” indicating a race type are displayed in an upper portion of the display screen. In the example of the display screen of FIG. 4, a setting of a difficulty level of race result prediction in organizing a program for the race is displayed as set odds. In the example of the display screen of FIG. 4, lanes, horse names, and riders are displayed as a result of organizing a program for the race. The lane is a lane number at the time when the racehorse running in the race starts. The horse name is a name of a racehorse assigned to the race. The rider is a name of a rider who is going to ride on the racehorse. In the example of the display screen of FIG. 4, the lane numbers and the riders are displayed as the result of organizing the program for the race, but only the names of the racehorses assigned to the race may be displayed as the result of organizing the program for the race. For example, only the horse names and the numbers assigned in the displayed order, such as 1 to 8, may be displayed as the result of organizing the program for the race. Information other than the lane numbers, the horse names, and the riders may be displayed as the result of organizing the program for the race.

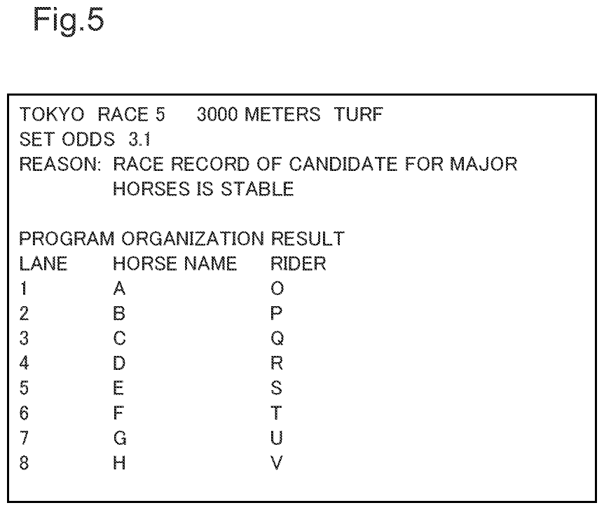

FIG. 5 is an example of a display screen further displaying a reason for the program organization result, as compared to the example of the display screen of FIG. 4. In the example of the display screen of FIG. 5, the reason for the program organization result is displayed as “the race record of the candidate for the horse is stable”. In the example of the display screen of FIG. 5, it is shown that the reason for the program organization result according to the set value of the odds is, for example, that a horse of which a race record is stable at a higher level than the other horses is included.

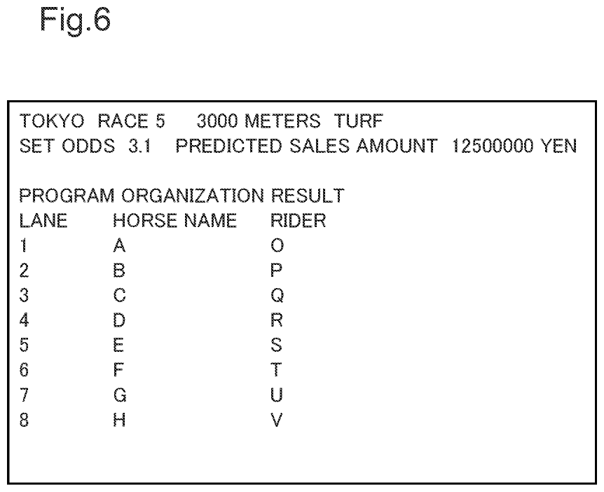

FIG. 6 is a display screen further displaying a predicted voting ticket sales amount, as compared to the example of the display screen of FIG. 4. In the example of the display screen of FIG. 6, the prediction of the voting ticket sales amount is displayed as a predicted sales amount. The predicted sales amount is a predicted value of a voting ticket sales amount in a case where the race is held based on the program organized by the organization model.

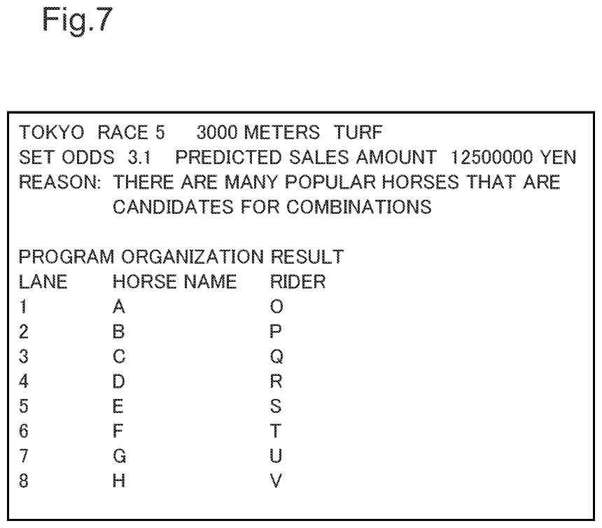

FIG. 7 is an example of a display screen further displaying a reason for the predicted sales amount, as compared to the example of the display screen of FIG. 6. In the example of the display screen of FIG. 7, the reason for the organization result is displayed as “there are many popular horses that are candidates for combinations”. In the example of the display screen of FIG. 7, it is shown that the reason for the increase in predicted sales amount is, for example, that many popular horses are included as candidates for combinations.

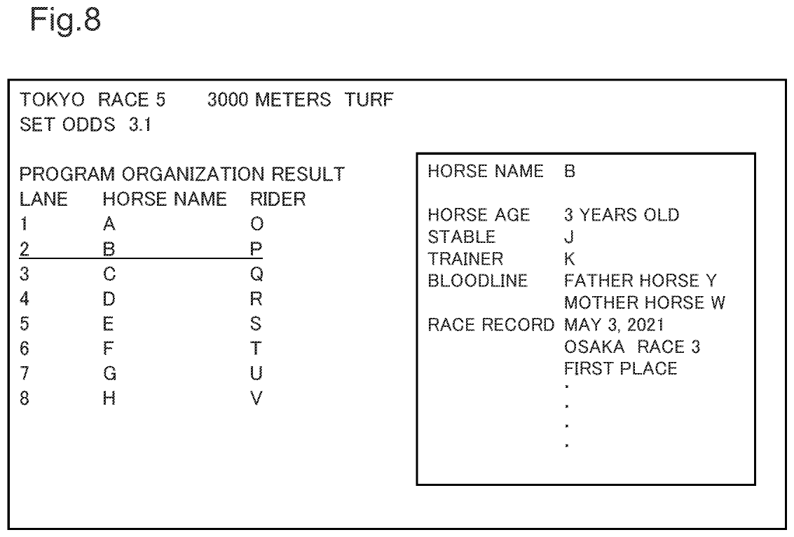

FIG. 8 is an example of a display screen further displaying information regarding a racehorse as reference information, as compared to the example of the display screen of FIG. 4. In the example of the display screen of FIG. 8, information regarding the racehorse “B” is displayed in a right frame. In the example of the display screen of FIG. 8, a horse age, a stable, a trainer, a bloodline, and a race record are displayed. In the example of the display screen of FIG. 8, for example, when a horse name is clicked, the output unit 14 may output information regarding a racehorse having the clicked horse name.

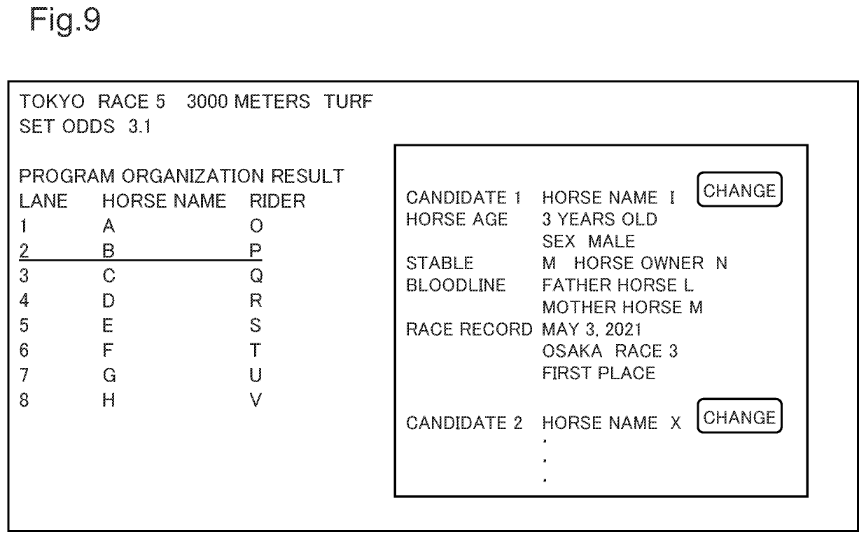

FIG. 9 is an example of a display screen further displaying a screen for changing the program organization result, as compared to the example of the display screen of FIG. 4. In the example of the display screen of FIG. 9, candidate racehorses for replacing the racehorse included in the organization result is displayed in a right frame of the display screen. In the example of the display screen of FIG. 9, candidate racehorses for replacing the racehorse “B” are displayed. In the example of the display screen of FIG. 9, for example, when a “change” button for candidate 1 is pressed, the racehorse “B” is replaced with a racehorse “I” in the program organization result. The selection of the racehorse to be replaced is performed, for example, as a person in charge of organizing the program operates the terminal device 30. In the example of the display screen of FIG. 9, for example, when a horse name is clicked, the output unit 14 may output candidate racehorses for replacing the racehorse having the clicked horse name.

In a case where an organization model is generated in the program organization system 10, the model generation unit 15 generates an organization model that organizes a program according to the setting of the difficulty level of race result prediction from the information regarding the race. For example, the model generation unit 15 generates the organization model, by learning, concerning a race performed in the past, a relationship of a program with information regarding the race and a difficulty level of the race. The organization model is a learning model that organizes a program according to a setting of a difficulty level of race result prediction from information regarding the race. The model generation unit 15 generates the organization model, for example, by deep learning using a neural network. The organization model may be generated outside the program organization system 10.

In a case where an organization model is generated by deep learning using a neural network, the model generation unit 15 may generate, for example, an organization model that changes data for each item and extracts an item having a large influence on an organization result based on a change in organization result as a reason for organization. For example, the model generation unit 15 changes data for each item included in the data input to the organization model, and extracts an item having a large influence on an organization result as a reason for organization.

The model generation unit 15 may generate the organization model using a learning algorithm based on factorized asymptotic Bayesian inference. When performing learning using a learning algorithm based on factorized asymptotic Bayesian inference, the model generation unit 15 classifies a case in accordance with decision tree-style rules with information regarding the race as input data and a program as correct answer data. Then, the model generation unit 15 generates a learning model using a linear model in which different explanatory variables are combined in each case. The model generation unit 15 generates the learning model by sequentially performing processes of optimizing a condition for classifying cases of data and optimizing a combination of explanatory variables to generate an organization model and delete an unnecessary organization model. The organization model generated by such a method for generating a learning model by combining different explanatory variables is capable of explaining an organization result by using the case classifying condition having a strong influence on a program organization result. Thus, the explanatory property of the program organization result is improved. Such a learning model generating method is disclosed in, for example, the specification of US 2014/0222741 A1. The learning algorithm used for machine learning for generating an organizational model is not limited to the above-described examples.

The storage unit 16 stores, for example, the organization model. When a plurality of organization models is used, the storage unit 16 stores the plurality of organization models. In a case where the program organization system 10 generates an organization model, the storage unit 16 may store data concerning a past race in which information regarding the race, a difficulty level of the race, and a program are associated with each other. The organization model used by the organization unit 13 may be stored in a storage means other than the storage unit 16.

The terminal device 30 acquires a program organization result from the program organization system 10. Then, the terminal device 30 outputs the program organization result, for example, to a display device that is not illustrated.

In a case where an organization model is selected by a user, the terminal device 30 acquires, for example, the name of the organization model input by an operation of the user. Then, the terminal device 30 outputs the input name of the organization model to the program organization system 10.

As the terminal device 30, for example, a smartphone, a tablet computer, a notebook computer, or a desktop computer is used. The terminal device used for the terminal device 30 is not limited to the above-described examples.

The information management server 20 is, for example, a server that stores or manages information regarding the race. The information management server 20 may be a plurality of servers installed according to the content of the information regarding the race. The information regarding the race may be stored in a storage device managed by the information management server 20.

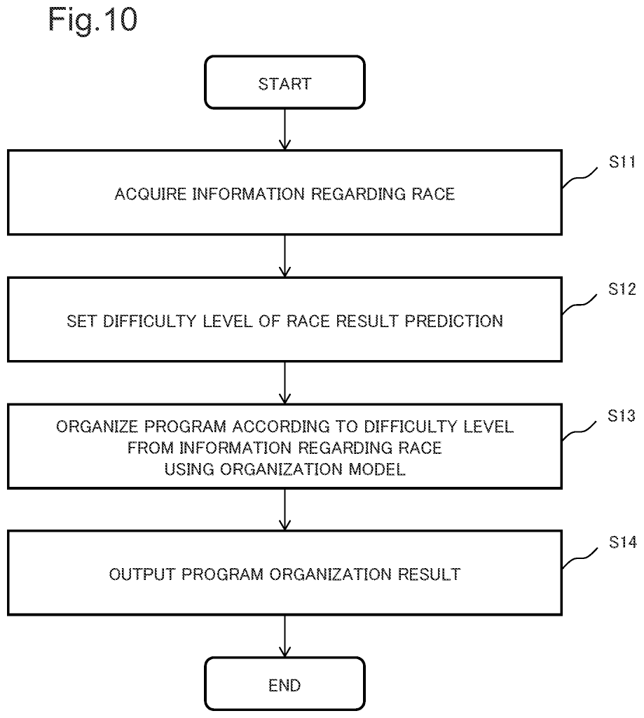

An operation in which the program organization system 10 organizes a program for a race will be described. FIG. 10 is a diagram illustrating an example of an operation flow when the program organization system 10 organizes a program for a race.

The acquisition unit 11 acquires information regarding a race for which a program is to be organized in public competition (step S11). The acquisition unit 11 acquires the information regarding the race, for example, from the information management server 20.

The setting unit 12 sets a difficulty level of race result prediction (step S12).

After the difficulty level of race result prediction is set, the organization unit 13 organizes a program according to the setting of the difficulty level of race result prediction from the information regarding the race acquired by the acquisition unit 11 using an organization model (step S13). The organization model is a learning model that organizes a program according to a setting of a difficulty level of race result prediction from information regarding the race.

After the program is organized, the output unit 14 outputs a result of organizing the program (step S14). The output unit 14 outputs the result of organizing the program, for example, to the terminal device 30.

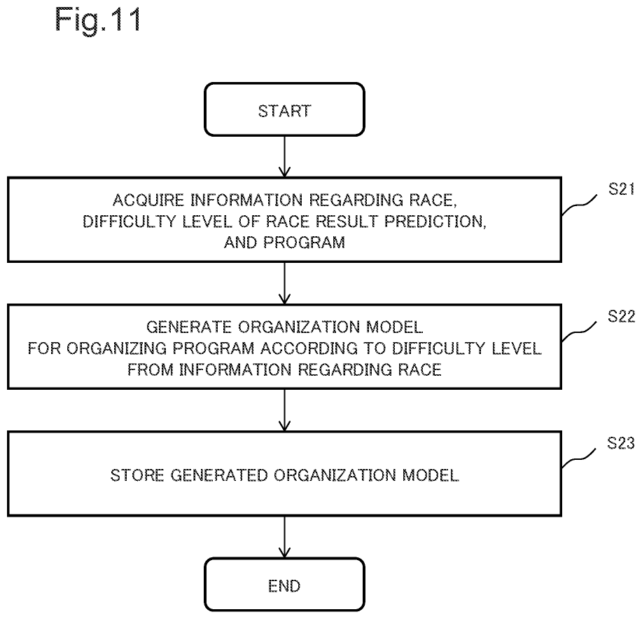

An operation when the program organization system 10 generates an organization model will be described. FIG. 11 is a diagram illustrating an example of an operation flow when the program organization system 10 generates an organization model.

The acquisition unit 11 acquires, concerning a race performed in the past, information regarding the race, a difficulty level of race result prediction, and a program (step S21). Concerning the race performed in the past, the information regarding the race, the difficulty level of race result prediction, and the program, are used as teacher data when the organization model is generated. As the difficulty level of race result prediction, for example, odds on voting tickets in a race performed in the past are used. After the information regarding the race, the difficulty level, and the program are acquired, the model generation unit 15 learns a relationship between the information regarding the race, the difficulty level, and the program, and generates an organization model that organizes a program according to a setting of a difficulty level from information regarding a race (step S22). After the organization model is generated, the model generation unit 15 stores the generated organization model in the storage unit 16 (step S23).

The program organization system 10 according to the present example embodiment acquires information regarding a race in public competition. Then, the program organization system 10 organizes a program according to a setting of a difficulty level of race result prediction using an organization model. By organizing the program using the organization model, the program for the race of the public competition can be easily organized. By organizing the program using the organization model, the program organization system 10 can organize the program without depending on a skill level of a person who organizes the program. By organizing the program according to the setting of the difficulty level, the program can be organized, for example, according to a targeted group of voting ticket purchasers. By organizing the program according to the targeted group of voting ticket purchasers, it can be promoted to purchase voting tickets.

In a case where a plurality of organization models, the program organization system 10 can further improve the program organizing accuracy according to the setting of the difficulty level of race result prediction. That is, by using the plurality of organization models, the program organization system 10 can organize a program in which a difference between the setting of the difficulty level of race result prediction and the difficulty level in the actual race result is reduced. For example, by using an organization model according to a rating of the race, the program organization system 10 can improve the program organizing accuracy even in a race for which a targeted group of purchasers is different.

In a case where a voting ticket sales amount is predicted together with the organization of the program, for example, it is easy to determine whether to adopt a result of organization by the program organization system 10 when the race is held.

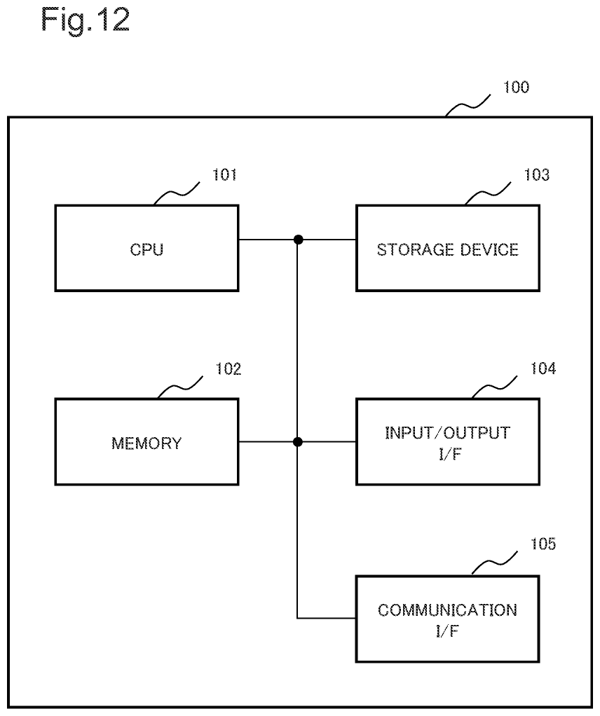

Each process in the program organization system 10 can be achieved by a computer executing a computer program. FIG. 12 illustrates an example of a configuration of a computer 100 that executes a computer program for the program organization system 10 to perform each process. The computer 100 includes a central processing unit (CPU) 101, a memory 102, a storage device 103, an input/output interface (I/F) 104, and a communication I/F 105.

The CPU 101 reads a computer program for performing each process from the storage device 103 and executes the computer program. The CPU 101 may be configured by a combination of a plurality of CPUs. The CPU 101 may be configured by a combination of a CPU and another type of processor. For example, the CPU 101 may be configured by a combination of a CPU and a graphics processing unit (GPU). The memory 102 includes a dynamic random access memory (DRAM) or the like, and temporarily stores a computer program to be executed by the CPU 101 and data that is being processed. The storage device 103 stores a computer program to be executed by the CPU 101. The storage device 103 includes, for example, a nonvolatile semiconductor storage device. As the storage device 103, another storage device such as a hard disk drive may be used. The input/output I/F 104 is an interface that receives an input from an operator and outputs display data and the like. The communication I/F 105 is an interface that transmits and receives data between the information management server 20 and the terminal device 30. The information management server 20 and the terminal device 30 may have a similar configuration.

The computer program used for executing each process can also be stored in a computer-readable recording medium that non-temporarily records data for distribution. As the recording medium, for example, a magnetic tape for recording data or a magnetic disk such as a hard disk can be used. Alternatively, an optical disk such as a compact disc read only memory (CD-ROM) can also be used as the recording medium. A non-volatile semiconductor storage device may also be used as the recording medium.

In public competition, for example, for each race, an organizer determines competitors or racehorses that will run in the race. A combination of competitors or racehorses that will run in the race is also called a program. The program for the race can have a great influence on the development of the race and the order of arrival. The prediction of the order of arrival in the race is one of the pleasures for voting ticket purchaser for the race. Therefore, the difficulty level of predicting the order of arrival in the race may influence on whether to purchase a voting ticket for the race and a purchase amount of the voting ticket for the race. For this reason, the organizer of the race needs to organize, for example, a program that is attractive to the voting ticket purchasers for the race. Meanwhile, many factors related to the race condition and the conditions of the competitors or racehorses that will run in the race may influence a race result. Therefore, a person in charge of organizing a program for the race may require a lot of knowledge and workload to organize the program in consideration of various factors that may influence a race result. For this reason, it is preferable to have a system capable of easily organizing a program for the race.

However, it has been difficult to expect a difficulty level of race result prediction, for example, with the technique described in the background art.

Therefore, in order to solve the aforementioned problem, an object of the present disclosure is to provide a program organization system and the like capable of easily organizing a program according to a setting of a difficulty level of race result prediction.

By using the program organization system and the like according to the present disclosure, for example, a person in charge of organizing a program for a race is able to make an appropriate decision in organizing the program for the race, referring to a result of organizing the program for the race optimized based on the setting of the difficulty level of race result prediction. That is, the program organization system can support decision making in race organization.

Some or all of the above-described example embodiments may be described as in the following supplementary notes, but are not limited to the following supplementary notes.

### [Supplementary Note 1]

A program organization system including:
at least one memory storing instructions; and
at least one processor configured to execute the instructions to:
acquire information regarding a race of public competition;
organize a program for the race based on a setting of a difficulty level of race result prediction, from the acquired information regarding the race of the public competition, by using an organization model that organizes the program according to the setting of the difficulty level of race result prediction, from the information regarding the race of the public competition; and
output the organized program.

### [Supplementary Note 2]

The program organization system according to supplementary note 1, in which
the difficulty level is set based on assumed odds on voting tickets for the race.

### [Supplementary Note 3]

The program organization system according to supplementary note 1 or 2, in which
the difficulty level is set to be higher as at least one of an index of a desire of a voting ticket purchaser for purchase for the race or an index of a skill level of the voting ticket purchaser for the race is higher.

### [Supplementary Note 4]

The program organization system according to supplementary note 1 or 2, in which
the organization model organizes a program according to the setting of the difficulty level of race result prediction, from the information regarding the race of the public competition, and predicts a voting ticket sales amount for the race to be performed based on the organized program.

### [Supplementary Note 5]

The program organization system according to supplementary note 1 or 2, in which
the at least one processor is further configured to execute the instructions to:
organize a program for the race using an organization model according to a rating of the race.

### [Supplementary Note 6]

The program organization system according to supplementary note 1 or 2, in which
the at least one processor is further configured to execute the instructions to:
output a reason for organization together with the organized program.

### [Supplementary Note 7]

The program organization system according to supplementary note 1 or 2, in which
the at least one processor is further configured to execute the instructions to:
output a candidate for a replacing competitor, in a case where a competitor included in the organized program is changed.

### [Supplementary Note 8]

The program organization system according to supplementary note 1 or 2, in which
the public competition is a horse race, and
the information regarding the race includes a race condition, a candidate racehorse that will run in the race, and an attribute of the candidate racehorse that will run in the race.

### [Supplementary Note 9]

The program organization system according to supplementary note 8, in which
the attribute of the racehorse includes at least one of age, sex, leg quality, race record, bloodline, and rider.

### [Supplementary Note 10]

The program organization system according to supplementary note 1 or 2, in which
the at least one processor is further configured to execute the instructions to:
generate an organization model that organizes a program according to a setting of a difficulty level of race result prediction from the information regarding the race of the public competition, by learning a relationship of program organization for a race of public competition with information regarding the race and a difficulty level of the race.

### [Supplementary Note 11]

A program organization method including:
acquiring information regarding a race of public competition;
organizing a program for the race based on a setting of a difficulty level of race result prediction, from the acquired information regarding the race of the public competition, by using an organization model that organizes the program according to the setting of the difficulty level of race result prediction, from the information regarding the race of the public competition; and
outputting the organized program.

### [Supplementary Note 12]

A non-transitory recording medium recording a program organization program that causes a computer to execute:
acquiring information regarding a race of public competition;
organizing a program for the race based on a setting of a difficulty level of race result prediction, from the acquired information regarding the race of the public competition, by using an organization model that organizes the program according to the setting of the difficulty level of race result prediction, from the information regarding the race of the public competition; and
outputting the organized program.

In addition, some or all of the configurations described in supplementary notes 2 to 8, which depend on the above-described supplementary note 1, can also depend on supplementary notes 11 and 12, with the same dependency relationship as supplementary notes 2 to 9. Furthermore, some or all of the configurations described as the supplementary notes can similarly depend on various recording means or systems for recording various pieces of hardware, software, and ware, as well as supplementary notes 1, 11, and 12, without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A program organization system comprising:
at least one memory storing instructions; and
at least one processor configured to execute the instructions to:
acquire information regarding a race of public competition;
organize a program for the race based on a setting of a difficulty level of race result prediction, from the acquired information regarding the race of the public competition, by using an organization model that organizes the program according to the setting of the difficulty level of race result prediction, from the information regarding the race of the public competition; and
output the organized program.

2. The program organization system according to claim 1, wherein
the difficulty level is set based on assumed odds on voting tickets for the race.

3. The program organization system according to claim 1, wherein
the difficulty level is set to be higher as at least one of an index of a desire of a voting ticket purchaser for purchase for the race or an index of a skill level of the voting ticket purchaser for the race is higher.

4. The program organization system according to claim 1, wherein
the organization model organizes a program according to the setting of the difficulty level of race result prediction, from the information regarding the race of the public competition, and predicts a voting ticket sales amount for the race to be performed based on the organized program.

5. The program organization system according to claim 1, wherein
the at least one processor is further configured to execute the instructions to:
organize a program for the race using an organization model according to a rating of the race.

6. The program organization system according to claim 1, wherein
the at least one processor is further configured to execute the instructions to:
output a reason for organization together with the organized program.

7. The program organization system according to claim 1, wherein
the at least one processor is further configured to execute the instructions to:
outputs a candidate for a replacing competitor, in a case where a competitor included in the organized program is changed.

8. The program organization system according to claim 1, wherein
the public competition is a horse race, and
the information regarding the race includes a race condition, a candidate racehorse that will run in the race, and an attribute of the candidate racehorse that will run in the race.

9. The program organization system according to claim 8, wherein
the attribute of the racehorse includes at least one of age, sex, leg quality, race record, bloodline, and rider.

10. The program organization system according to claim 1, further comprising:
the at least one processor is further configured to execute the instructions to:
generate an organization model that organizes a program according to a setting of a difficulty level of race result prediction from the information regarding the race of the public competition, by learning a relationship of program organization for a race of public competition with information regarding the race and a difficulty level of the race.

11. A program organization method comprising:
acquiring information regarding a race of public competition;
organizing a program for the race based on a setting of a difficulty level of race result prediction, from the acquired information regarding the race of the public competition, by using an organization model that organizes the program according to the setting of the difficulty level of race result prediction, from the information regarding the race of the public competition; and
outputting the organized program.

12. The program organization method according to claim 11, wherein
the difficulty level is set based on assumed odds on voting tickets for the race.

13. The program organization method according to claim 11, wherein
the difficulty level is set to be higher as at least one of an index of a desire of a voting ticket purchaser for purchase for the race or an index of a skill level of the voting ticket purchaser for the race is higher.

14. The program organization method according to claim 11, wherein
the organization model organizes a program according to the setting of the difficulty level of race result prediction, from the information regarding the race of the public competition, and predicts a voting ticket sales amount for the race to be performed based on the organized program.

15. The program organization method according to claim 11, further comprising
organizing a program for the race using an organization model according to a rating of the race.

16. The program organization method according to claim 11, further comprising
outputting a reason for organization together with the organized program.

17. The program organization method according to claim 11, further comprising
outputting a candidate for a replacing competitor, in a case where a competitor included in the organized program is changed.

18. The program organization method according to claim 11, wherein
the public competition is a horse race, and
the information regarding the race includes a race condition, a candidate racehorse that will run in the race, and an attribute of the candidate racehorse that will run in the race.

19. The program organization method according to claim 18, wherein
the attribute of the racehorse includes at least one of age, sex, leg quality, race record, bloodline, and rider.

20. A non-transitory recording medium recording a program organization program that causes a computer to execute:
acquiring information regarding a race of public competition;
organizing a program for the race based on a setting of a difficulty level of race result prediction, from the acquired information regarding the race of the public competition, by using an organization model that organizes the program according to the setting of the difficulty level of race result prediction, from the information regarding the race of the public competition; and
outputting the organized program.
